(19) United States
(12) Patent Application Publication
(10) Pub. No.: US 2020/0110219 A1
(43) Pub. Date: Apr. 9, 2020

(54) Ultra-Compact Planar Mode Size Converter with Integrated Aspherical Semi-Lens

(71) Applicant: Rutgers, The State University of New Jersey, New Brunswick, NJ (US)

(72) Inventors: Siamak Abbaslou, Highland Park, NJ (US); Wei Jiang, Highland Park, NJ (US); Robert Gatdula, Matawan, NJ (US)

(73) Assignee: Rutgers, The State University of New Jersey, New Brunswick, NJ (US)

(21) Appl. No.: 16/489,232

(22) PCT Filed: Feb. 27, 2018
(86) PCT No.: PCT/US18/19938

§ 371 Date: Aug. 27, 2019

Related U.S. Application Data
(60) Provisional application No. 62/463,941, filed on Feb. 27, 2017.
(60) Provisional application No. 62/484,185, filed on Apr. 11, 2017.

(51) Int. Cl. G02B 6/14; G02B 6/122

(52) U.S. Cl. CPC G02B 6/14; G02B 2006/12102; G02B 6/1228

(57) ABSTRACT

An optical beam transformer includes a taper structure where the structure width is varied, an integrated aspherical semi-lens structure having a straight proximal end formed adjacent to a distal end of the taper structure to be in direct contact therewith, and a convex semi-lens section having a curved proximal end in direct contact with a curved distal end of the integrated aspherical semi-lens structure.

### CROSS-REFERENCE TO RELATED APPLICATIONS

This application claims priority under 35 U.S.C. § 119(e) to U.S. Provisional Patent Application No. 62/484,185, filed Apr. 11, 2017, 2017 and U.S. Provisional Patent Application No. 62/463,941, filed Feb. 27, 2017. The foregoing applications are incorporated by reference herein.

### GOVERNMENT INTERESTS

The invention disclosed herein was made, at least in part, with government support under Grant No. N66001-12-1-4246 from Defense Advanced Research Projects Agency (DARPA). Accordingly, the U.S. Government has certain rights in this invention.

### FIELD

This document relates generally to photonic (optical) devices. More particularly, this document relates to ultra-compact planar mode size converters with integrated aspherical semi-lens.

### BACKGROUND

Photonic integrated circuits use light rather than electrons to perform a wide variety of optical functions such as routing information around chips. Recent developments in nanostructures, metamaterials, and silicon technologies have expanded the range of possible functionalities for these highly integrated optical chips. Photonic Integrated Circuits (“PICs”) in Silicon-On-Insulator (“SOI”) have great potential for highly integrated and highly scalable photonic functions. Mode size converters technology can have various applications in designing compact, efficient PICs devices.

Large-scale PICs represent a promising technology to achieve high-capacity optical interconnects that are employed in high-performance computing systems and data centers. They have the potential to provide low-cost, compact optical I/O chips due to their compatibility with highly-scalable, mature Si fabrication technology. The integration of high-performance light sources is a major challenge for Si-based optical I/O chips due to the inherent lack of light-emitting functions in Si crystal. Si/III-V hybrid lasers are promising candidates for light sources in Si I/O chips. In order to achieve low-loss optical coupling with a flip-chip bonding configuration a compact, efficient mode size converter is needed. The mode size converters can also be integrated into laser diode in order to narrow the beam divergence. Beam Expanders (“BEs”) are an essential component of integrated photonics. BEs are generally optical devices that are widely used in matching the modes of waveguides of different widths. In this regard, BEs take a collimated beam of light and expand its mode width (or used in reverse to focus the light or reduce its mode diameter).

### SUMMARY

The present solution provides a compact and low loss optical beam transformer. The optical beam transformer includes a taper structure with a varying structure width. The optical beam transformer also includes an integrated aspherical semi-lens structure having a straight proximal end formed adjacent to a distal end of the taper structure. The straight proximal end is in direct contact with the distal end of the taper structure. The optical beam transformer further includes a convex semi-lens section having a curved proximal end in direct contact with a curved distal end of the integrated aspherical semi-lens portion.

The taper structure includes a parabolic taper portion having a parabolic cross-sectional shape and configured to receive light from a light source. The taper structure also includes a rapid linear taper portion having a proximal end with a first width smaller than a second width of a distal end of the linear taper portion. The proximal end is formed adjacent to a straight edge of the parabolic portion so as to be in direct contact with the straight edge of the parabolic portion.

In some embodiments, the straight distal end of the convex semi-lens section is connected to a waveguide having a width substantially identical to a distal end width of the convex semi-lens section. In some embodiments, the taper structure is a nonadiabatic taper.

In some embodiments, the taper structure, the integrated aspherical semi-lens structure, and the convex semi-lens section are formed in a single semiconducting material layer. In some embodiments, the single semiconducting material layer includes silicon.

In some embodiments, the optical beam transformer includes a silicon dioxide layer, and the single semiconducting material layer is disposed on the silicon dioxide layer. In some embodiments, the optical beam transformer further includes a silicon substrate layer, and the silicon dioxide layer is stacked between the single semiconducting material layer and the silicon substrate layer. In some embodiments, the optical beam transformer further includes a second silicon dioxide layer cladding on a surface of the single semiconducting material layer.

In some embodiments, the overall length of the optical beam transformer is less than or equal to about six times wavelength of light from the light source. The wavelength is from about 1520 nm to about 1570 nm. In some embodiments, the optical beam transformer has a waveguide width ratio of about 20:1. In some embodiments, the optical beam transformer is configured to produce a Gaussian-like intensity profile with plane wavefront at least in the convex semi-lens section of the optical beam transformer.

In some embodiments, light is coupled in from the taper structure, and a beam width of light is expanded after light passes through the optical beam transformer. In some embodiments, light is coupled in from the convex semi-lens section, and the beam width of light is reduced after light passes through the optical beam transformer.

In some embodiments, the optical beam transformer is configured to operate with a 220 nm Silicon-On-Insulator platform or a 260 nm Silicon-On-Insulator platform. In some embodiments, the parabolic taper portion has a length of from about 0.9 μm to about 1 μm and the rapid linear taper portion has a length of from about 3.61 μm to about 4.54 μm. In some embodiments, the parabolic taper portion has a width of from about 1.7 μm to about 1.776 μm, and the rapid linear taper portion has a width of from about 3.3 μm to about 3.725 μm. In some embodiments, the convex semi-lens section has a length of from about 0.78 μm to about 1.03 μm. In some embodiments, the distal end width of the convex semi-lens section has a width of about 10 μm.

### DESCRIPTION OF THE DRAWINGS

The present solution will be described with reference to the following drawing figures, in which like numerals represent like items throughout the figures.

FIGS. 1(a)-(b) (collectively “FIG. 1”) show an example of a beam expander (“BE”); FIG. 1(a) shows scanning electron micrographs of the BE; and FIG. 1(b) shows different segments of the BE.

FIGS. 2(a)-(b) (collectively “FIG. 2”) show exemplary structures of a BE.

FIG. 3(a) shows transmission efficiency for nonadiabatic linear and parabolic taper compared to the BE design with a waveguide width ratio of 20:1 at 1550 nm wavelength; FIG. 3(b) shows a comparison in transmission and reflection between a BE; and a linear taper; FIG. 3(c) shows a simulated transmission spectrum of a BE.

FIGS. 4(a)-(d) (collectively “FIG. 4”) show a comparison between a BE and a linear taper; FIG. 4(a) shows an electric field intensity profile for a BE and FIG. 4(b) shows an electric field intensity profile for a linear taper; FIG. 4(c) shows an electric field phase profile for a BE; and FIG. 4(d) shows an electric filed phase profile for a linear taper.

FIGS. 5(a)-(c) show coupling ratio of TE₀ from input waveguide into five different even modes provided by scattering matrix calculation: BE (FIG. 5(a)), linear taper (FIG. 5(b)), and 54.2 μm linear taper (FIG. 5(c)); FIG. 5(d) shows an electric field profile at the end waveguide.

FIG. 6(a) shows a pointing vector integral in the vertical direction for three different points in sub-lens structure with the electric field in the center shown in the inset; and FIG. 6(b) shows a gap spacing profile between two sub-lenses from at the center point with the transmission of the thin film for different gap spacing shown in the inset.

FIGS. 7(a)-(b) (collectively “FIG. 7”) show experimental measurements of average insertion loss and error bars over a 50 nm bandwidth in a BE (FIG. 7(a)) and a linear taper (FIG. 7(b)).

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

In integrated photonic circuits, every component should be designed in a way to reduce the material, processing, and packaging costs. Therefore, a small, efficient wideband mode size converter in silicon photonics is a promising solution, specifically for scalable high-speed on/off-chip optical interconnects and wavelength multiplexing/demultiplexing with array waveguide gratings.

Mode size converters can be classified into lateral tapers, vertical tapers, or Multi-Mode Interference (“MMI”) based mode size converters, segmented tapers, or photonic crystals. In lateral tapers, the width of the guiding layer is changed. These tapers are easy to fabricate, but the disadvantage is that it needs a sharp termination point of the upper waveguide, making the process complicated. In vertical tapers, the thickness of the guiding layer is changed along the device, but due to critical variations of the thickness, these tapers are not widely used. Mode size converters based on MMI excite several modes, and the waveguide is terminated in such a way that interference of these multiple modes yields to maximum coupling. Although these class of mode size converters are much shorter, they are less flexible and only allow a limited expansion of the spot size. The segmented tapers are similar to MMI mode size converters, but instead, they are optimized based on each segment length. Although they are more flexible compared to MMI mode size converters, they have limited expansion and suffer from low fabrication tolerances. Photonic crystal spot size converters can be relatively short and efficient, but they have the relatively low bandwidth. Nonadiabatic mode size converters have been studied in shallow etched lens-assisted focusing taper which shows losses of about 1 dB for TE mode in the 20-μm-long taper. Mode size converters using genetic optimization algorithm have demonstrated 1.4 dB loss for the 15.4 μm-long taper for 18:1 waveguide width ratio. Recently, a segmented-stepwise mode-size converter designed via particle swarm optimization for a 20-μm-long taper demonstrated 0.62 dB loss for 24:1 waveguide width ratio. In optimized designs, the idea is to divide the taper length into digitized segments and maximize the coupling to the end waveguide. A transformation optics approach has also been used to design reflection-less tapers. Recently wavefront shaping through emulated curved space in waveguide has been demonstrated.

The present solution generally relates to a design for an optical beam expander/focuser based on a rapid taper and an integrated aspherical semi-lens structure. This device can convert the mode from two planar silicon waveguides with a width ratio greater than 20:1 in a very short length (e.g., less than 10 microns), which is more than one order of magnitude shorter than a typical adiabatic linear taper. Notably, this is the shortest taper between two different waveguides with a 20:1 width ratio reported. The present solution experiences only around −0.65 dB insertion loss over the entire C-band optical spectrum. This is possible by incorporating a semi-lens structure and using of Particle Swarm Optimization (“PSO”) algorithm to find the best parameters, which enables correcting the deformed wavefront and reducing coupling to higher order modes.

The present solution impacts on/off-chip optical interconnects and wavelength multiplexing/demultiplexing device, optical phased array, spatial light modulator and many other applications. The present solution has many advantages. For example, the present solution reduces an overall footprint of an electrical device, which saves material, processing and packaging costs.

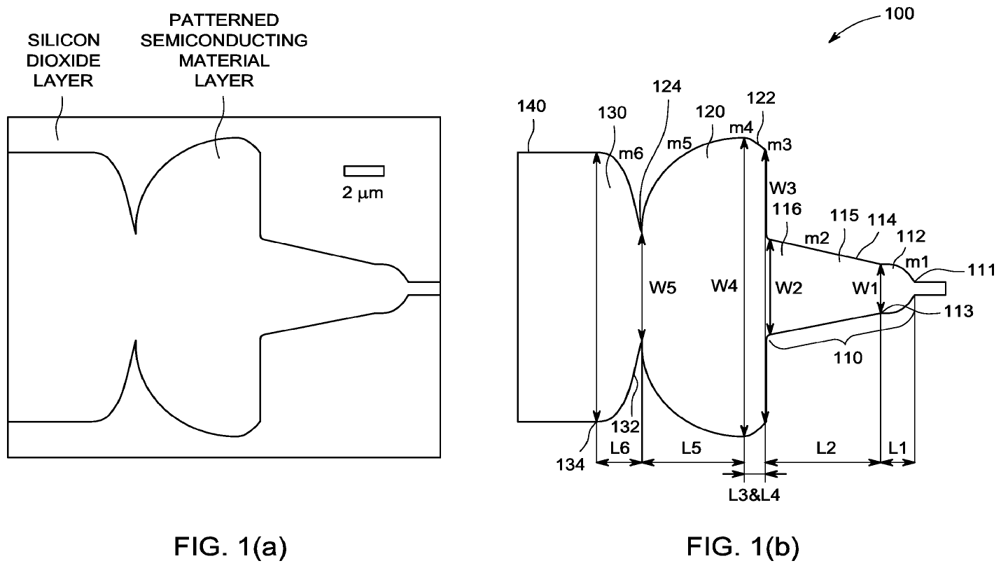

FIG. 1 illustrates an example of a beam expander (“BE”) 100. FIG. 1(a) shows scanning electron micrographs of the BE 100, and FIG. 1(b) shows different segments of the BE 100. As shown in FIG. 1(b), the BE 100 comprises a taper structure 110, an integrated aspherical semi-lens section 120, and a convex semi-lens section 130. The taper structure 110 may have a varying structure width. The taper structure 110 includes a parabolic taper portion 112 and a rapid linear taper portion 115. The parabolic taper portion 112 has a parabolic cross-sectional shape and is configured to receive light from a light source (not shown) through a proximal end 113 of the parabolic taper portion 112. The rapid linear taper portion 115 include a proximal end 114 with a first width smaller than a second width of a distal end 116 of the linear taper portion. The proximal end 114 is formed adjacent to a straight edge 113 of the parabolic taper portion 112 so as to be in direct contact with the straight edge 113 of the parabolic taper portion 115. The integrated aspherical semi-lens structure 120 includes a straight proximal end 122 formed adjacent to a distal end 116 of the taper structure 110. The straight proximal end 122 is in direct contact with the distal end 116 of the taper structure 110. The convex semi-lens section 130 include a curved proximal end 132 in direct contact with a curved distal end 124 of the integrated aspherical semi-lens portion 120. The distal end 134 of the convex semi-lens section 130 is coupled to a waveguide 140.

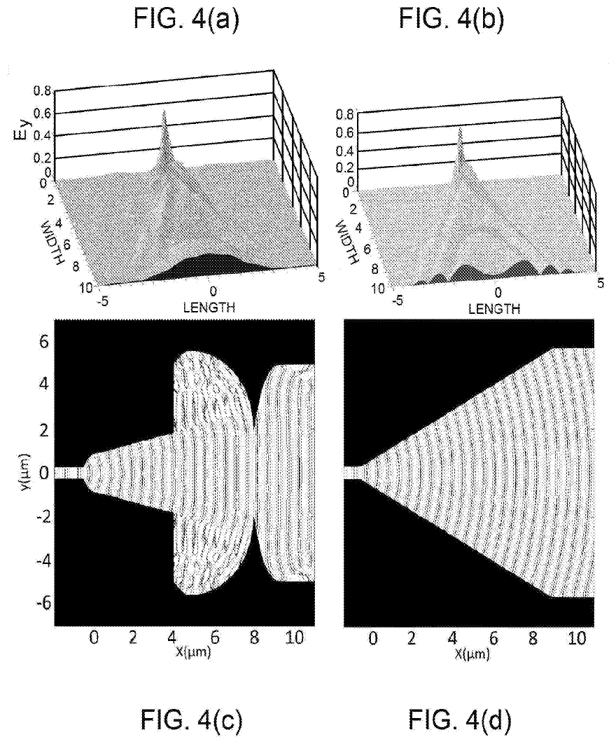

Notably, the taper structure 110, the integrated aspherical semi-lens structure 120, and the convex semi-lens section 130 are formed in a single semiconducting material layer. In some embodiments, the single semiconducting material layer includes silicon. In some embodiments, the BE 100 has a collective length of L_{BE}=6λ₀, which is significantly shorter than a comparable conventional taper BE having a length 20 times greater than L_{BE}. As such, the BE can be fabricated with minimal cost as compared to multi-layer BE architectures and be used in more compact devices. Also, a Gaussian-like intensity profile with plane wavefront is produced at least in the convex lens section 130 as shown in FIG. 4(c). This is not the case in a conventional taper BE as shown in FIG. 4(d) in which a curved wavefront is produced therethrough. Accordingly, in the BE 100 interference effects are suppressed as compared to that of a convention taper BE, as shown in FIGS. 4(a)-(b). FIG. 4(a) shows the intensity of the propagating electric field evolving through the BE 100, and FIG. 4(b) shows the intensity of the propagating electric field evolving through a conventional taper BE, where the ripples represent interference.

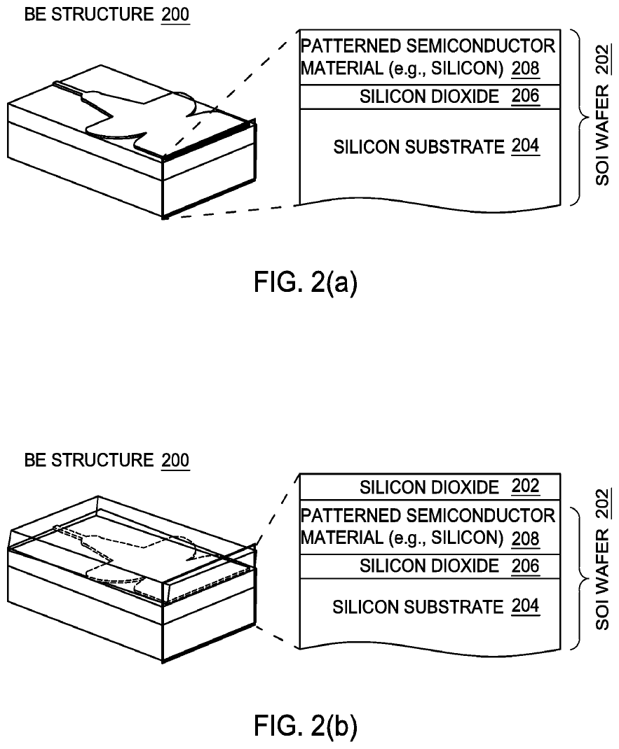

Referring now to FIG. 2(a), a cross-section of an exemplary BE structure 200 is illustrated. The BE structure 200 is fabricated on an SOI wafer 202. The SOI wafer 202 comprises a silicon layer 204 as substrate and a silicon dioxide layer 206. A semiconducting material layer 208 is disposed on the silicon dioxide layer 206. The semiconducting material layer 208 can include, but is not limited to, silicon. The BE pattern is formed in the semiconducting material layer 208. In some scenarios, the pattern is formed using a JEOL JBX-6300FS high-resolution e-beam lithography system operating at 100 keV on a 120-nm-thick XR-1541-006 hydrogen-silsesquioxane (HSQ) negative e-beam resist. The pattern 208 is transferred to the silicon layer via an Oxford Plasmalab 100 ICP etcher, using an HBr+Cl₂ based chemistry for vertical and smooth sidewalls. In some scenarios, the BE structure 200 may further include an additional silicon dioxide layer 210, as shown in FIG. 1(b), such that the semiconducting material layer 208 is sandwiched between two silicon dioxide layers 206 and 210.

In some scenarios, light is coupled in from the taper structure, and a beam width of light is expanded after light passes through the optical beam transformer. In some scenarios, light is coupled in from the convex semi-lens section, and the beam width of light is reduced after light passes through the optical beam transformer.

In some scenarios, the present solution comprises a compact, low loss BE based on the idea of a taper and an integrated aspherical lens structure with a low measured insertion loss (e.g., −0.65 dB). The BE can be fabricated through a single step process of patterning and etching. This structure is compared to other types of mode conversion structures through the introduced figure of merit. The wavefront distortion reduction was approached through means of maximizing coupling into a fundamental mode while minimizing coupling to higher order modes within a short distance on the order of a few wavelengths. The proposed BE has a figure of merit of 2.8, which is more than 5 times higher than its corresponding linear taper. This structure has the potential of being incorporated into grating couplers or array waveguide gratings.

Beam expanders are an essential component of integrated photonics. They are widely used in matching the modes of waveguides of different widths. Simply spreading optical power of waveguide modes from a narrow waveguide to a wider waveguide can be readily achieved through certain taper shapes if one does not care about the higher-order modes excited in this process. However, many applications require that the width transformation preserves the light in the lowest order mode after the transition. Furthermore, the recent trend of silicon photonics towards ultra-compact devices demands such mode-order-preserving width expansion to be completed in an ultra-short distance.

Generally, such mode-order-preserving expansion requires a very slow or adiabatic taper with a length substantially larger than the final width of the waveguide. It has been challenging to reach 1:1 ratio for the expansion length and the final width. To couple optical waveguides with different cross-sections and modal sizes, slowly varying linear or parabolic tapers can be used. However, in order to minimize the loss and satisfy the adiabatic taper condition, these taper lengths need to be sufficiently long (e.g., Lₜₐₚₑᵣ>70λ₀, while λ₀=1550 nm), which is greater than the mode beating length satisfied by the parabolic slowly varying taper. For nonadiabatic short tapers (e.g., 35λ₀<Lₜₐₚₑᵣ<70λ₀), the power from the fundamental mode is substantially coupled to the second order mode. Whereas in the rapidly varying taper (e.g., Lₜₐₚₑᵣ<35λ₀), some portion of the input power can couple not only to second but to even higher order modes, so the insertion loss accumulates almost exponentially regardless of the taper profile.

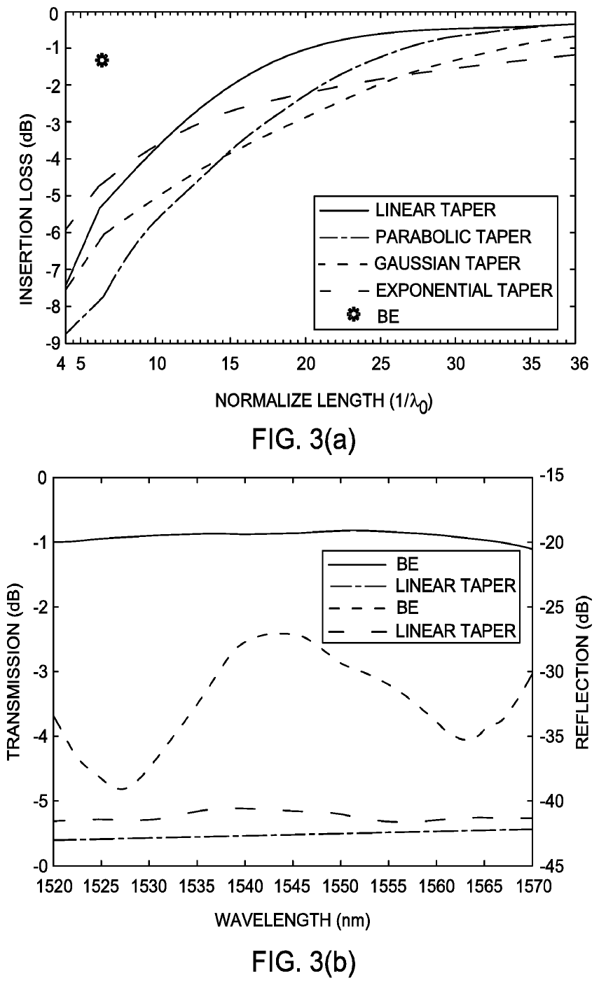

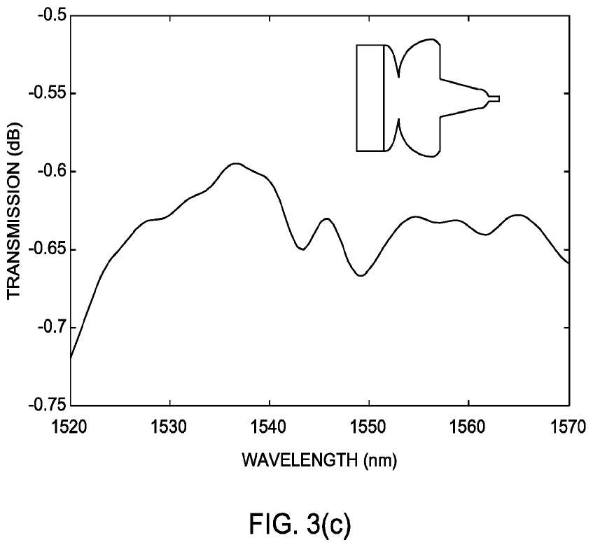

The insertion loss of the rapidly varying tapers (e.g., 20:1 waveguide width ratio) with linear, parabolic, exponential and Gaussian profiles are shown for 1550 nm wavelength in FIG. 3(a). It is observed that in nonadiabatic regime the parabolic taper is not acting as efficient taper profile compared to linear and exponential tapers. In nonadiabatic tapers, the rapidly varying sidewalls cause multiple scattering and coupling of light to higher order modes, which consequently decreases the power delivered to the fundamental mode. This effect is strongly related to the taper length and doesn't depend on the wavelength.

The present solution shows that mode-order-preserving waveguide expansion can be achieved through a composite adiabatic and nonadiabatic structure in an extremely short length comparable to the final width. First, an adiabatic mode-width expansion structure is designed. The structure is divided into multiple segments, each following a power-law width profile, and the width is required to be continuous at the interfaces between segments. Then, an optimal structure with the lowest loss in a large design space is identified using an advanced optimization algorithm. Surprisingly, the optimized structure practically breaks the width-continuity condition. It produces a composite structure mixed with adiabatic and nonadiabatic segments. This shows that an adiabatic structure is intrinsically incapable of reaching the 1:1 regime for the expansion length and final width. Nonadiabatic structures are introduced to not only expand the mode width but to transform and correct the wavefront.

As noted above, the present solution concerns a compact, low loss, BE with a waveguide width ratio greater than 20:1 in a very short length (e.g., L_{BE}≈6λ₀). The structure consists of multiple segments in which each segment has a smooth curvature with discontinuities at the boundaries between each segment. Numerical exploration for finding the best profile fit for select criteria lead to a structure which consists of a rapid taper and semi-lens structures. When a beam propagates through rapid varying tapers, the wavefront is distorted due to the interaction from sidewall reflections. Any deviation from wavefront propagation determined by ideally shaped components may be called scattering. In terms of waveguide modes, this wave-front deformation is considered to cause coupling into other modes. Therefore, the deformed beam is described as a superposition of the fundamental mode and higher-order modes. Correcting the ripples in the wavefront can reduce the scattering effect and coupling to the higher order modes. To optimize the structure, coupling to the end waveguide is increased by reducing wavefront deformation, which improves the sphericity of the wavefront and corrects the aberration. This type of semi-lens structure is known as an aspheric lens. The geometry of each segment is defined by Mathematical Equation (1):

$${w}_{i} ( x ) = ( {w}_{i} - {w}_{i + 1} ) {( \frac{{L}_{i} - x}{{L}_{i}} )}^{{m}_{i}} + {w}_{i + 1} for i = 1 \text{:} 6 \qquad ( 1 )$$

in which wᵢ, Lᵢ, mᵢ are the width, length, and curvature of the i^{th} segment. The curvature provides the freedom inside each segment to make either linear, convex or concave sidewalls. The BE design is optimized with 6 segments, corresponding to a total of 18 parameters. The structure is simulated by 3D Finite Difference Time Domain (“FDTD”) utilizing an evolutionary PSO algorithm. PSO shows a great capability in optimizing critical passive devices with like Y-junction couplers compared to other methods such as junction matrix method or genetic algorithm optimization. To reduce the backscattering and loss due to coupling to higher order modes, the power delivered to the fundamental TE mode of the output waveguide is optimized. This is calculated by the overlap integral averaged over 50 nm bandwidth from 1520 nm to 1570 nm. The design parameters for a BE design that can be operated with a 260 nm SOI platform are listed in the table below:

| Parameter | Values (μm) |
|---|---|
| m₁, m₂, m₃, m₄,m₅, m₆ | 3, 1.1, 0.01, 2, 0.32, 2.55 |
| W₁, W₂,W₃, W₄, W₅, W₆ | 1.7, 3.3, 10.1, 10, 3.19, 9 |
| L₁, L₂, L₃, L₄, L₅, L₆ | 1.0, 3.61, 0.05, 0.7, 3.11, 1.03 |

In simulations, it was demonstrated that −0.85 dB of insertion loss has 0.5 dB bandwidth of 69 nm. Transmission is almost flat over a 50 nm bandwidth, as shown in FIG. 3(b). In this design, the first 50% of the BE's length is considered as a rapid taper and the rest as part of the semi-lens. For comparison, a linear taper of similar length is shown, demonstrating −5.5 dB of insertion loss. To characterize the improvement in wavefront deformation and correction of the optimized BE compared to a linear taper, the amplitude and phase of the E_{y} field shown in FIG. 4 were considered. For a BE shown in FIG. 4(a), the ripples in the amplitude diminish after propagation through the semi-lens in which represent itself as the flattened wavefront (FIG. 4(c)). However, in a linear taper shown in FIG. 4(b), the amplitude has more ripples due to scattering which expands through propagation, while the corresponding phase plot has more ripples which represent coupling to higher order modes and loss (FIG. 4(d)). In non-optimized BE the semi-lens structure cannot effectively correct the wavefront and light may couple to higher order modes besides the fundamental mode.

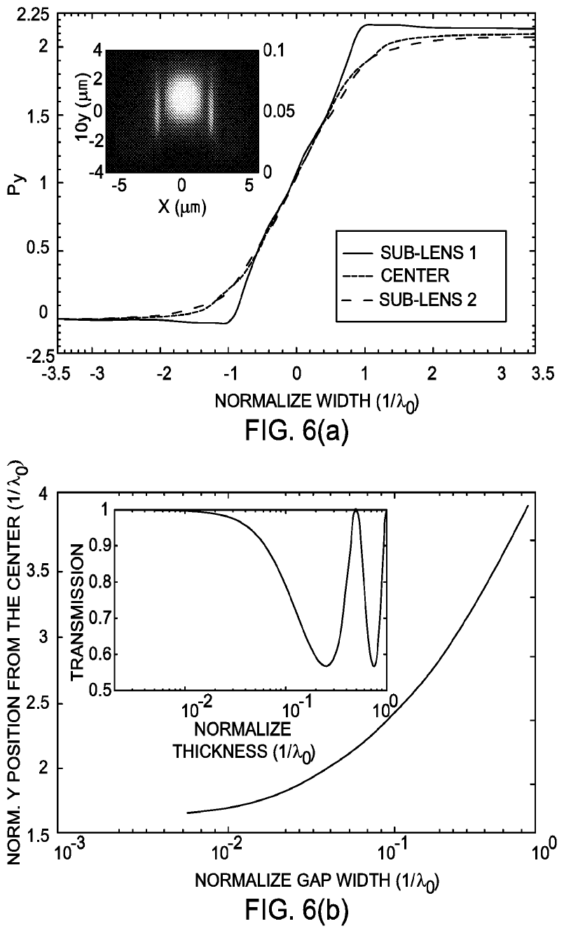

To demonstrate the effect of key design parameters on BE performance, the width and curvature of the sub-lens (m₄) and (w₄) are varied. To keep the integrity of the sub-lens, w₃ is changed according to w₄. The calculation reveals that transmission spectra can change from 45 to 83% which depends strongly on the sub-lens width at the interface. In addition to designing each sub-lens parameter individually, the lensing performance of the BE is affected by the relative design of two sub-lens. The relative effect of each sub-lens curvatures (m₅) and (m₆) on the performance of BE was investigated. Varying the curvature of the two sub-lens (m₅) and (m₆) from 1 to 4 made the sub-lens change from linear to a convex shape. By increasing the curvature of both sides, the transmission increased due to the following effects. First, reducing the back reflection induced scattering and wavefront distortion effectively corrected the wavefront as it is shaped relative to the wavefront (aspherical lens). Second, increasing the curvature and reducing the gap between sub-lens, allowed more light to couple between the two sub-lenses (FIG. 6). In case the BE parameters are not designed properly, the profile exhibits some curvature, and a portion of light will be coupled to higher order modes.

The BE with new values of L₂, L₃, w₄, and w₆ that are derived by 10 and 20% from the optimized values were simulated as examples. To qualitatively study the BE's rapid taper and semi-lens parts individually, the rapid taper was replaced with a wide MMI waveguide. In this case, the wavefront was too distorted such that (a) it cannot be corrected with the semi-lens structure which is reflected in coupling to higher order modes and (b) the efficiency of the BE is diminished.

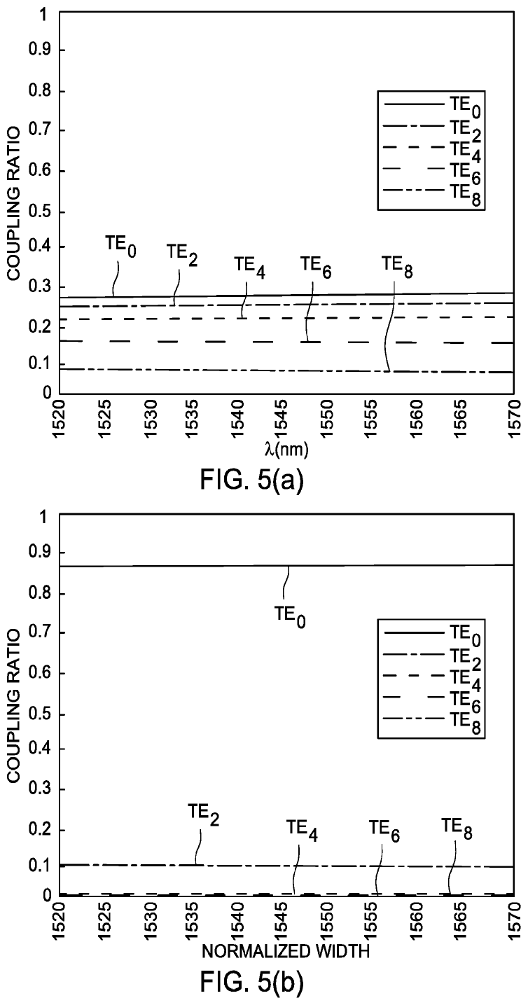

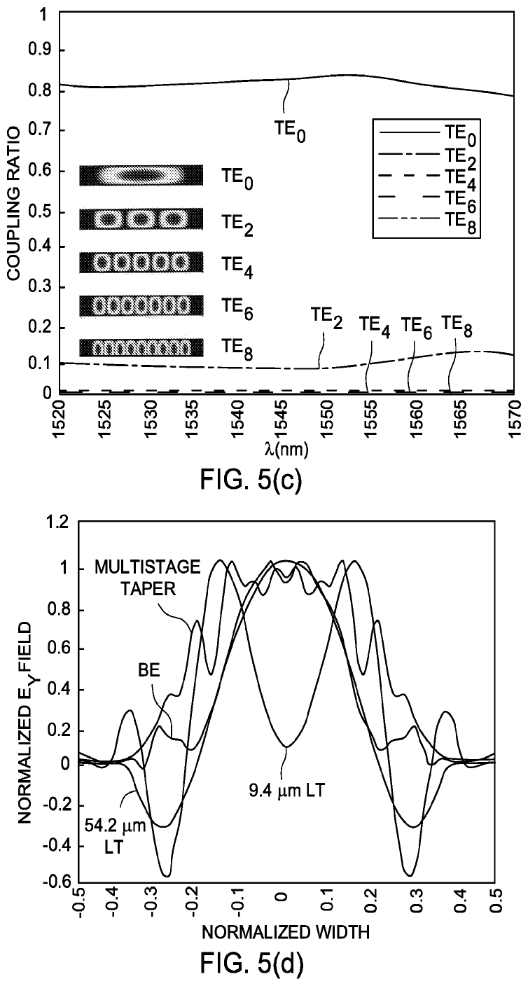

To study how coupling happens for each single mode, mode propagation was simulated based on the scattering matrix technique. With the fundamental TE mode considered as the input, coupling to the first four higher order even modes TE₂, TE₄, TE₆, and TE₈ were considered noting that the overlap integrals between fundamental TE₀ and odd TE modes are zero. In a 6λ₀ long linear taper as shown in FIG. 5(a), coupling into the fundamental mode is low with the light is coupling almost evenly to all other modes. In a 354 long linear taper as shown in FIG. 5(b), most of the light tends to stay in the fundamental mode with coupling less than 10% to the TE₂ mode and relatively negligible coupling to all other modes. As for the 6λ₀ long BE as shown in FIG. 5(c), a similar performance is shown to that of the 354 long linear taper. The superposition of the output modes for each of these three cases is shown in FIG. 5(d). Qualitatively, the power coupled to each mode is directly related to the overlap integral. Thus, more overlap to the output fundamental mode increases the overall coupling efficiency.

In fast varying sidewall tapers, the dramatic wavefront deformation does not allow the use of the Fresnel or paraxial approximations—leading to the mode coupling theory. Instead, the Rayleigh-Sommerfield diffraction formula or fully vectorial Maxwell equations with no approximation needed to be solved.

Instead, of solving the Rayleigh-Sommerfield diffraction formula, a Poynting vector integral and power distribution through the vertical direction of the lens was considered. As shown in FIG. 6(a), the power in the semi-lens is focused in around 2.2λ₀ of its width, which applies to different parts of the semi-lens. At the 2.2λ₀ point, the gap width is below 0.1λ₀, which is the spacing between two sub-lenses measured and shown in FIG. 6(b). The transmission is around 80%—based on the calculated thin film transmission with the corresponding width shown in the inset of FIG. 6(b). So even for the smallest width of the semi-lens located in the center around 80% of light transferred to the second sub-lens, the electric field profile at the midpoint is shown in the inset of FIG. 6(a). The air-gap between the two sub-lenses does contribute to some reflection as shown in FIG. 6(a) from the difference between the two sub-lenses, which this has a negligible effect on the mode transmission.

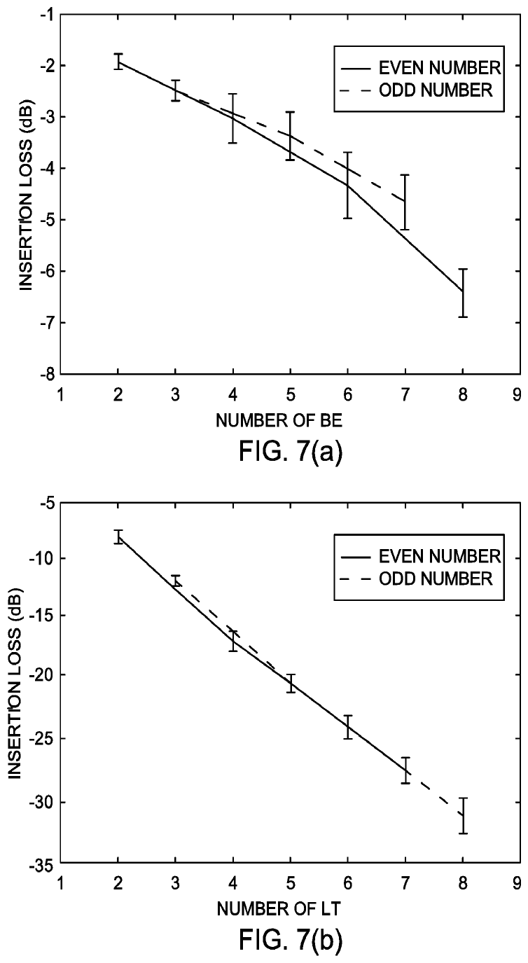

Measurement of the transmission spectra was done by coupling TE-polarized light from an HP 8168F tunable laser via a single-mode polarization maintaining fiber array into sub-wavelength grating couplers that deliver light into the in-plane silicon waveguide structures. The scanning electron microscope image of the device is shown in FIG. 1(a). The transmission at each wavelength is recorded via an HP 8153 photo-detector. A reference waveguide without BEs was used to cancel out all the coupling and waveguide loss effects. The insertion loss measurement results for multiple BEs are shown in FIG. 7(a) with measurement results for linear tapers of similar lengths for comparison (FIG. 7(b)). Based on measurement results the BE has −0.9 dB and the corresponding linear taper has −4.5 dB insertion loss in average for through 50 nm bandwidth.

To compare the performance of the BE with the linear taper and other designs, a Normalized Expansion Ratio (“NER”) was introduced as a figure of merit, considering the length of the taper, both waveguide widths, and the transmission. An ideal BE delivers most of the optical power in the shortest length between two different waveguides with a large width ratio. This figure of merit is defined by the following mathematical Equation (3),

$$E R = \frac{{W}_{out} / {W}_{i n}}{{L}_{Taper} / {λ}_{0}} \cdot {T}_{avg} \qquad ( 3 )$$

where wₒᵤₜ/wᵢₙ the output is over input waveguide width ratio, L_{Taper}/λ₀ is the normalized BE length to the center transmission wavelength and T_{avg} is the average transmission in a linear scale.

The NER is calculated for different mode converter designs and is shown in the table below:

| BE design | Length (μm) | NER |
|---|---|---|
| segmented-stepwise MSC | 20 | 1.71 |
| Horizontal SSC | 60 | 0.89 |
| Irregular mode converters | 20 | 1.89 |
| Lens assisted | 20 | 1.53 |
| Adiabatic taper | 120 | 0.30 |
| Linear Taper | 9.5 | 0.5 |
| BE | 9.5 | 2.8 |

As evident from the above-discussion, the present solution concerns a compact, low loss BE designed based on the idea of a rapid taper and an integrated aspherical lens structure with a low measured insertion loss (e.g., −0.85 dB, 0.65 dB). The BE can be fabricated through a single step process of patterning and etching. This structure is compared to other types of mode conversion structures through the introduced figure of merit. The wavefront distortion was reduced through means of maximizing coupling into a fundamental mode while minimizing coupling to higher order modes within a short distance on the order of a few wavelengths. The proposed BE has a figure of merit of 2.8, which is more than 5 times higher than its corresponding linear taper. This structure has a potential incorporated in grating couplers or array waveguide grating.

In another example, BE was optimized for 220 nm SOI platform with 3 μm buried oxide (BOX) layer and 500 nm silicon dioxide top cladding shown in FIG. 2(b). The shape of the optimal design was based on an evolutionary PSO (particle swarm optimization) algorithm shown in FIG. 1(b). The BE structure includes multiple segments, each having a curvature parameter. The width of each segment varies along the propagation axis x, as defined in Equation (4):

$${w}_{i} ( {x}_{i} ) = ( {w}_{i} - {w}_{i + 1} ) {\vert \frac{{x}_{i} = {L}_{i}}{{L}_{i}} \vert}^{{m}_{i}} + {w}_{i + 1} \qquad ( 4 )$$

where wᵢ, Lᵢ, mᵢ are the width, length and curvature of the segment, and

$${x}_{i} = x - {\sum }_{j = 1}^{i - 1} {L}_{j} ,$$

Lⱼ, i=1, 2 . . . 6. The curvature (mᵢ≥0 to avoid divergence) is intended to provide freedom inside each segment to make linear, convex, or concave tapers. The width must be continuous throughout the beam expander, but the curvature can be different between adjacent segments.

The optimized parameters for length, width, and curvature of six segments of the new design are listed in the table below:

| Parameter | Values (μm) |
|---|---|
| m₁, m₂, m₃, m₄, m₅, m₆ | 3.00, 0.95, 0.01, 2.00, 0.32, 0.86 |
| W₀, W₁, W₂, W₃, W₄, W₅, W₆ | 0.50, 1.776, 3.725, 9.00, 9.54, |
| | 3.20, 10.00 |
| L₁, L₂, L₃, L₄, L₅, L₆ | 0.90, 4.54, 0.02, 0.86, 2.92, 0.78 |

The structure was simulated employing 3D finite difference time domain (FDTD). The simulated transmission spectrum is shown in FIG. 3(c). The average insertion loss for the new design was −0.65 dB for entire c-band communication wavelength which is 0.20 dB better than the BE based on a 260 nm SOI platform.

The present solution may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

As used in this document, the singular form “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

The term “about” refers to a range of values which would not be considered by a person of ordinary skill in the art as substantially different from the baseline values. For example, the term “about” may refer to a value that is within 20%, 15%, 10%, 9%, 8%, 7%, 6%, 5%, 4%, 3%, 2%, 1%, 0.5%, 0.1%, 0.05%, or 0.01% of the stated value, as well as values intervening such stated values.

All of the apparatus, methods, and algorithms disclosed and claimed herein can be made and executed without undue experimentation in light of the present disclosure. While the invention has been described in terms of preferred embodiments, it will be apparent to those having ordinary skill in the art that variations may be applied to the apparatus, methods, and sequence of steps of the method without departing from the concept, spirit, and scope of the invention. More specifically, it will be apparent that certain components may be added to, combined with, or substituted for the components described herein while the same or similar results would be achieved. All such similar substitutes and modifications apparent to those having ordinary skill in the art are deemed to be within the spirit, scope, and concept of the invention as defined.

The features and functions disclosed above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

What is claimed is:

1. An optical beam transformer, comprising:
a taper structure with a varying structure width;
an integrated aspherical semi-lens structure having a straight proximal end formed adjacent to a distal end of the taper structure to be in direct contact therewith; and
a convex semi-lens section having a curved proximal end in direct contact with a curved distal end of the integrated aspherical semi-lens structure.

2. The optical beam transformer of claim 1, wherein the taper structure comprises:
a parabolic taper portion having a parabolic cross-sectional shape and configured to receive light from a light source; and
a rapid linear taper portion having a proximal end with a first width smaller than a second width of a distal end of the linear taper portion, the proximal end formed adjacent to a straight edge of the parabolic taper portion so as to be in direct contact therewith.

3. The optical beam transformer of claim 1, wherein the convex semi-lens section comprises a straight distal end which is connected to a waveguide having a width substantially identical to a distal end width of the convex semi-lens section.

4. The optical beam transformer of claim 1, wherein the taper structure is a nonadiabatic taper.

5. The optical beam transformer of claim 1, wherein the taper structure, the integrated aspherical semi-lens structure, and the convex semi-lens section are formed in a single semiconducting material layer.

6. The optical beam transformer of claim 1, wherein the single semiconducting material layer comprises silicon.

7. The optical beam transformer of claim 5 further comprising a silicon dioxide layer, wherein the single semiconducting material layer is disposed on the silicon dioxide layer.

8. The optical beam transformer of claim 7 further comprising a silicon substrate layer, wherein the silicon dioxide layer is stacked between the single semiconducting material layer and the silicon substrate layer.

9. The optical beam transformer of claim 7 further comprising a second silicon dioxide layer cladding on a surface of the single semiconducting material layer.

10. The optical beam transformer of claim 2, wherein the overall length of the optical beam transformer is less than or equal to about six times wavelength of light from the light source.

11. The optical beam transformer of claim 10, wherein the wavelength is between about 1520 nm and about 1570 nm.

12. The optical beam transformer of claim 1 having a waveguide width ratio of about 20:1.

13. The optical beam transformer of claim 1, wherein the optical beam transformer is configured to produce a Gaussian-like intensity profile with plane wavefront at least in the convex semi-lens section of the optical beam transformer.

14. The optical beam transformer of claim 1, wherein light is coupled in from the taper structure, and a beam width of light is expanded after light passes through the optical beam transformer.

15. The optical beam transformer of claim 1, wherein light is coupled in from the convex semi-lens section, and the beam width of light is reduced after light passes through the optical beam transformer.

16. The optical beam transformer of claim 1, wherein the optical beam transformer is configured to operate with a 220 nm Silicon-On-Insulator platform or a 260 nm Silicon-On-Insulator platform.

17. The optical beam transformer of claim 2, wherein the parabolic taper portion has a length of from about 0.9 μm to about 1 μm, and the rapid linear taper portion has a length of from about 3.61 μm to about 4.54 μm.

18. The optical beam transformer of claim 2, wherein the parabolic taper portion has a width of from about 1.7 μm to about 1.776 μm, and the rapid linear taper portion has a width of from about 3.3 μm to about 3.725 μm.

19. The optical beam transformer of claim 1, wherein the convex semi-lens section has a length of from about 0.78 μm to about 1.03 μm.

20. The optical beam transformer of claim 1, wherein the distal end width of the convex semi-lens section has a width of about 10 μm.
